(19) United States
(12) Patent Application Publication
(10) Pub. No.: US 2019/0266710 A1
(43) Pub. Date: Aug. 29, 2019

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Tsuyoshi Oya, Kawasaki-shi (JP)

(21) Appl. No.: 16/287,401

(22) Filed: Feb. 27, 2019

(30) Foreign Application Priority Data
Feb. 28, 2018 (JP) 2018-034735

(51) Int. Cl. G06T 5/00; G06T 7/90; H04N 9/77; H04N 9/64

(52) U.S. Cl. CPC G06T 5/009; H04N 9/64; H04N 9/77; G06T 7/90

(57) ABSTRACT

An image processing apparatus includes a setting unit configured to set a color profile corresponding to an image format selected from a plurality of image formats, a conversion unit configured to convert an input image into an image in the selected image format. The setting unit sets, when the input image is converted into an image in a first image format, a color profile in which a color value corresponding to a white color indicating predetermined brightness is assigned to a maximum signal value of the input image, and sets, when the input image is converted into an image in a second image format having a wider dynamic range than a dynamic range of the first image format, a color profile in which the color value corresponding to the white color indicating the predetermined brightness to a signal value smaller than the maximum signal value of the input image.

### BACKGROUND OF THE INVENTION

### Field of the Invention

One disclosed aspect of the embodiments relates to an image processing technique for processing an image for displaying or the like.

### Description of the Related Art

Conventionally, various methods have been proposed for generating an image having a high dynamic range (hereinafter referred to as HDR) by expanding a dynamic range (hereinafter referred to as DR) of image information from an imaging apparatus such as a camera. Meanwhile, in a case where an HDR image is displayed on an existing display apparatus having a standard DR narrower than HDR, the HDR image cannot be displayed correctly as it is. Therefore, it is necessary to convert the HDR image into a standard DR image by compression or tone mapping, for example. Hereinafter, the standard DR will be referred to as a standard dynamic range (SDR), in contrast to HDR. One example of a technique for performing tone mapping on HDR image information to obtain SDR image information is discussed in Japanese Patent Application Laid-Open No. 2005-45804. Although an image generated by this technique is based on the HDR image information, the image is actually an SDR image in which DR is compressed into SDR. Hereinafter, the SDR image generated by the tone mapping will be referred to as a DR compressed image.

In these days, a display apparatus having a wide DR is also being in widespread use, and accordingly, it is becoming possible to display an image in a format having a wide DR such as an HDR image, while maintaining the wide DR. As described above, in the present state, various display apparatuses are present in a mixed manner, including a display apparatus capable of displaying an HDR image as an example of an image format having a wide DR and a display apparatus capable of displaying only an existing SDR image in an image format having a narrow DR. Japanese Patent Application Laid-Open No. 2015-172956 discusses an example of a technique for generating an image file that can be displayed by either a display apparatus capable of displaying an HDR image or a display apparatus capable of displaying only an SDR image. In the technique discussed in Japanese Patent Application Laid-Open No. 2015-172956, a DR compressed image (i.e., an SDR Image) is generated from an HDR image by using tone mapping. Difference information between the HDR image and the SDR image is attached to the DR compressed image in a form of metadata, and the DR compressed image and the meta data are encoded as an image file. With this arrangement, the display apparatus capable of displaying only an SDR image can display the DR compressed image, i.e., the SDR image, while the display apparatus capable of displaying an HDR image can generate and display the HDR image based on the DR compressed image and the difference information in the form of metadata.

### SUMMARY OF THE INVENTION

An image processing apparatus according to an exemplary embodiment of the disclosure includes a setting unit, a conversion unit, and an output unit. The setting unit is configured to set a color profile corresponding to an image format selected from a plurality of image formats. The conversion unit is configured to convert an input image into an image in the selected image format, and an output unit configured to output the image after the conversion by the conversion unit with at least the color profile attached to the image. The setting unit sets, when the input image is converted by the conversion unit into an image in a first image format, a color profile in which a color value corresponding to a white color having predetermined brightness is assigned to a maximum signal value of the input image. The setting unit further sets, when the input image is converted by the conversion unit into an image in a second image format having a wider dynamic range than a dynamic range of the first image format, a color profile in which the color value corresponding to the white color having the predetermined brightness to a signal value smaller than the maximum signal value of the input image.

Further features of the disclosure will become apparent from the following description of exemplary embodiments with reference to the attached drawings.

### BRIEF DESCRIPTION OF THE DRAWINGS

FIGS. 1A to 1C illustrate an example of a schematic configuration and a function of an image processing apparatus according to an exemplary embodiment.

FIGS. 2A to 2D illustrate an example of an existing color profile setting.

FIGS. 3A to 3D illustrate an example of a color profile setting according to the exemplary embodiment.

### DESCRIPTION OF THE EMBODIMENTS

According to the prior art technique, image files having different image formats, such as HDR images and SDR images, can be correctly displayed. However, in a case where an image is displayed using an image file by the above-described technique, a dedicated function such as image display/edit software capable of handling the above-described difference information is required.

Hereinafter, exemplary embodiments will be described in detail with reference to the accompanying drawings.

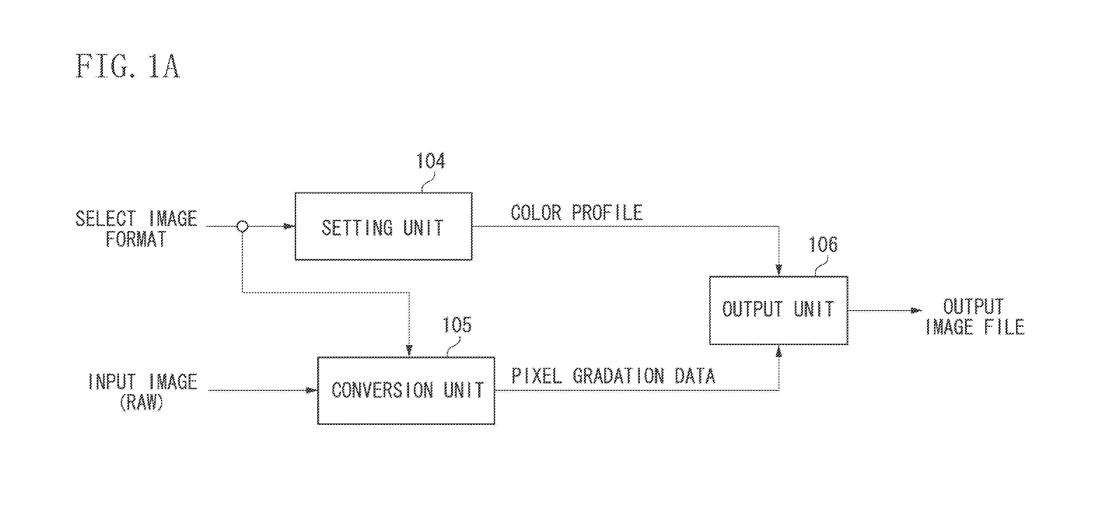

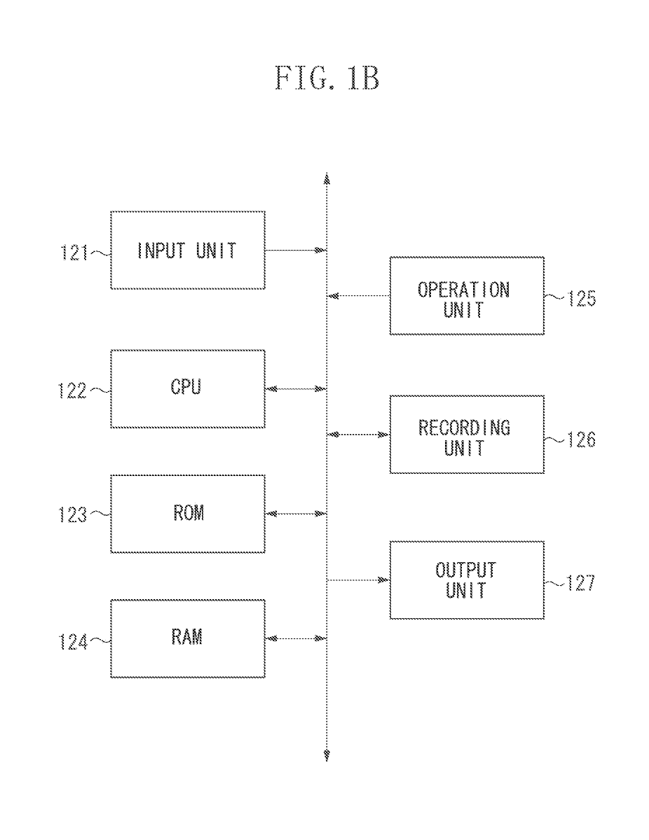

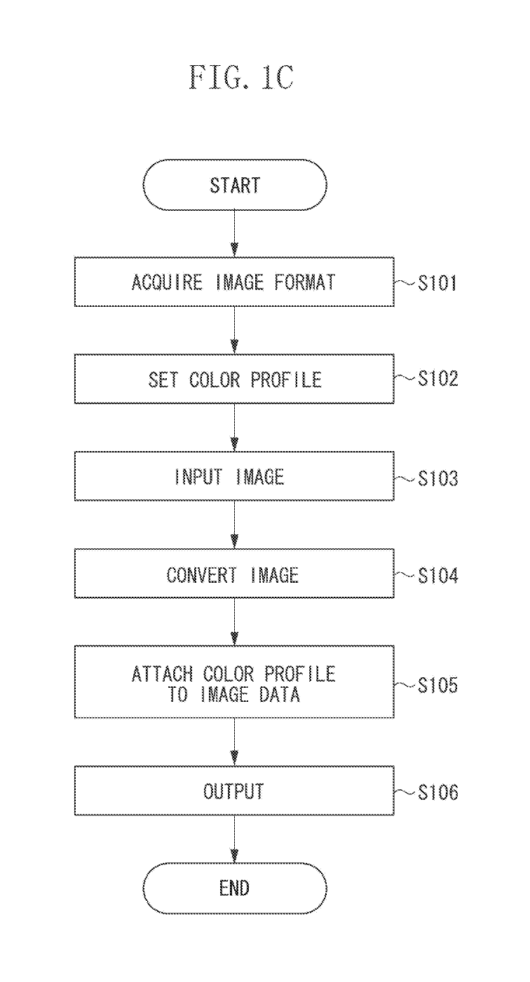

FIG. 1A is a block diagram illustrating a schematic functional configuration of an image processing apparatus of an exemplary embodiment. FIG. 1B is a block diagram schematically illustrating a hardware configuration of the image processing apparatus of the present exemplary embodiment. FIG. 1C is a flowchart illustrating processing procedure in the image processing apparatus of the present exemplary embodiment.

First, before description with reference to FIGS. 1A to 1C, images in different image formats in the present exemplary embodiment, for example, images having different dynamic ranges (referred to as DRs), and a case where such images are displayed will be discussed. In the following description, a case is given as an example where a high dynamic range (referred to as HDR) image having a wide DR and a standard dynamic range (referred to as SDR) image having a DR narrower than HDR are displayed.

As described above, in a case where an HDR image is supplied to a display apparatus that is compatible with SDR narrower than HDR, the HDR image cannot be displayed correctly as it is. Therefore, it is necessary to convert the HDR image into an SDR image by using compression or tone mapping. On the other hand, in a case where an HDR image is displayed on a display apparatus that supports HDR, image information having a wide DR in the HDR image can be displayed, while maintaining the wide DR. An HDR standard includes SMPTE ST2084 (i.e., Perpetual Quantizer, hereinafter referred to as PQ), ARIB STD-B67 (i.e., HybridLog-Gamma, hereinafter referred to as HLG), and ITU-R BT.2100.

A feature of the HDR standard lies in a definition of a signal tone (a tone indicated by a signal value). In the case of an existing SDR, a signal tone is associated with a color from black to white, while in the case of HDR, even a signal tone associated with brightness exceeding brightness of white in SDR can be defined. For example, in the case of HLG, it is possible to define a signal up to a level corresponding to 12 times a luminance of a reference white in SDR. In addition, in the case of PQ, it is possible to define a signal up to a level corresponding to 100 times a luminance of a reference white (10,000 nits), assuming that the reference white in SDR is 100 nits. One nit is one cd/m² and is a luminance of uniform brightness of one candela per square meter.

Thus, not only the dynamic range but also image signals to be defined are different between SDR and HDR. In the future, along with spread of HDR compliant display apparatus and HDR images, it is expected that SDR image and HDR image will be handled together in information device such as a personal computer and a mobile device. It is therefore important to consider how the SDR image and the HDR image should be displayed.

There is a color management system (hereinafter referred to as CMS) using a so-called color profile as a handling scheme in a case where images and display apparatuses having different formats, standards, and characteristics coexist. In other words, a relationship between a signal and a color is defined for each of the images and the display apparatuses in advance in the color profile, and an image signal is converted in the CMS so that the color is appropriately transferred with reference to the color profile. As an example, a case is described where an image to which a standard red, green, blue (sRGB) color profile is attached is displayed on an AdobeRGB (Adobe®) monitor. In this example, software including the CMS first converts red, green, blue (RGB) pixel values of the image into characteristic values of a profile connection space (hereinafter referred to as PCS) in accordance with a profile definition of sRGB. An XYZ or LAB color space is used for the PCS. Next, the characteristic values of the PCS are converted into RGB pixel values in accordance with an AdobeRGB profile of the monitor of the display apparatus. By such image signal conversion, an sRGB image is correctly displayed on the monitor having AdobeRGB characteristics.

In addition, the HDR standard is the same as an SDR in that the HDR standard also defines a relationship between a tone signal and a color. By appropriately setting HDR by the color profile, the HDR image can be appropriately displayed using an existing system without using an HDR dedicated image file format or software tool.

In this way, it is effective to handle HDR by using the color profile in interoperation and compatibility with an existing SDR image. However, in an existing color profile setting, since signal values (tone values) for expressing a tone are assigned to levels from black to white, signal values of the HDR image may be converted into darker signal values than those of the SDR image. As an example, in a case where a color profile is set by setting 10,000 nits corresponding to a maximum tone in PQ as a white level, it is expected that a luminance of the whole image will be converted into a luminance of one-hundredth compared with the SDR image, and thus a display image will become dark. Therefore, in a case where the existing color profile defined by black to white is set for the HDR image, there is a concern that brightness is mapped by a relative value and the HDR image is displayed darkly, and thus the HDR image may not be displayed correctly on a monitor of an SDR compatible display apparatus.

In the image processing apparatus of the present exemplary embodiment, in a case where an input image is output after conversion of an image format thereof, a color profile in accordance with the image format at the time of the conversion of the input image is set. For example, in a case where the input image is converted into an SDR image format, a color profile is set in such a manner that a color value corresponding to a white color is assigned to a maximum signal value in DR of the image. For example, in a case where the input image is converted into an image of HDR image format having DR wider than SDR, a color profile is set such that a color value corresponding to a white color is assigned to a signal value smaller than a maximum signal value in DR of the image. After the image format is converted, the color profile is attached to the image and the image is output.

Hereinafter, image processing according to the present exemplary embodiment will be described with reference to FIGS. 1A to 1C, 2A to 2D, and 3A to 3D.

An image processing apparatus illustrated in FIG. 1A includes functions of a conversion unit 105, a setting unit 104, and an output unit 106 may be implemented as specialized circuits or functions, modules including program instructions that are executed by a processor. The image processing apparatus converts an input image in accordance with an image format selected from a plurality of image formats, and outputs the converted image as an image file.

The conversion unit 105 illustrated in FIG. 1A receives the input image and information indicating the selected image format (hereinafter referred to as image format information). The setting unit 104 receives the image format information.

Here, the input image is image information having a wide DR captured by an imaging apparatus such as a digital camera. In the present exemplary embodiment, it is assumed that the input image is RAW data of a digital camera, as an example. The RAW data includes a digital value indicating an amount of light for each pixel received by an image capturing device of the digital camera.

In addition, the image format information indicates an image format selected from image formats of a plurality of standards such as sRGB and AdobeRGB as SDR standards and BT.2100 (PQ) and BT.2100 (HLG) as HDR standards. In the present exemplary embodiment, the image format is selected by a user, for example, but it may also be selected by software. Since a tone curve of BT.2100 can be selected from PQ and HLG, hereinafter a tone curve for BT.2100 in the case of PQ is referred to as BT.2100:PQ, and a tone curve for BT.2100 in the case of HLG is referred to as BT.2100:HLG.

The conversion unit 105 performs image conversion processing to convert the input image into an image in the image format indicated by the image format information. In the image conversion processing, a pixel tone of the RAW data as the input image is converted into a pixel tone in accordance with the image format. Details of the image conversion in accordance with the image format will be described below. The image data after the image conversion by the conversion unit 105 is sent to the output unit 106.

The setting unit 104 sets or generates a color profile based on the image format information. Although details will be described below, in a case where the input image is converted into an SDR image in the conversion unit 105, the setting unit 104 sets a color profile in which a color value corresponding to a white color having predetermined brightness is assigned to a maximum signal value in DR of the image. Also, as details described below, in a case where the input image is converted into an HDR image in the conversion unit 105, the setting unit 104 sets a color profile in which a color value corresponding to a white color having predetermined brightness is assigned to a signal value smaller than the maximum signal value in DR of the image. Data of the color profile set by the setting unit 104 is sent to the output unit 106.

The output unit 106 converts the image data after the image conversion by the conversion unit 105 into image data in a predetermined file format, and generates and outputs an image file to which the data of the color profile set by the setting unit 104 is attached. The file format may be any suitable format. It may include Joint Photographic Experts Group (JPEG), and Tagged Image File Format (TIFF). The image file is binary data encoded in accordance with the file format. Any other file format may be used as long as the color profile can be attached to the image file in accordance with a specification thereof. The image file output from the output unit 106 may be sent to a display apparatus (not illustrated) for display, recorded in a recording device (not illustrated), or transmitted over a network, for example.

FIG. 1B illustrates an example of a hardware configuration in which processing in each block illustrated in FIG. 1A is implemented.

In FIG. 1B, a central processing unit (CPU) 122 controls operations in the image processing apparatus in an integrated manner, and performs various types of image processing and calculations. A read-only memory (ROM) 123 is a non-volatile memory that stores a program and the like necessary for the CPU 122 to execute control processing of each unit and various types of image processing and calculation processing. A random-access memory (RAM) 124 functions as a main memory, a work area, and the like for the CPU 122. The CPU 122 loads the necessary program and the like from the ROM 123 into the RAM 124 when executing control and processing, and executes the program and the like to implement various types of control and processing. Some or all of the functions of each component of the image processing apparatus illustrated in FIG. 1A may be implemented by execution of a program by the CPU 122. Alternatively, at least some of the functions of respective components may be implemented by dedicated hardware and the other functions of respective components may be implemented by software. Operation of the dedicated hardware may also be controlled by the CPU 122.

A recording unit 126 records, for example, various types of data necessary for the CPU 122 to perform processing using the program, data after image processing, and the like. The recording unit 126 may include any one of a hard disk drive (HDD), a solid state drive (SSD), and a detachable memory card, or a combination thereof.

An operation unit 125 includes operation devices (not illustrated) such as a power button, various switches, a keyboard, a mouse, and a touch panel, and acquires operation signals from the operation devices. The operation devices may be implemented outside the image processing apparatus, and in that case, the operation unit 125 serves as an interface that acquires signals from the operation devices and sends the signals to the CPU 122. In a case where the above-described image format information indicates the image format selected by the user, the user can select the image format by operating the operation unit 125.

An input unit 121 acquires the above-described input image. In a case where the image processing apparatus of the present exemplary embodiment is included in an imaging apparatus such as a digital camera, the input unit 121 also includes an imaging device that captures an image. In a case where the image processing apparatus is a personal computer or the like, the input unit 121 includes, for example, a communication interface that communicates with a digital camera, an interface to which a semiconductor memory or the like taken out from the digital camera is connected. Further, the image format information may be acquired by the input unit 121.

An output unit 127 outputs the above-described image file. The output unit 127 may include an interface that outputs data of the image file to a display apparatus such as a monitor. The output unit 127 may also include the display apparatus.

The configuration illustrated in FIG. 1B is an example, and other than above-described configuration may be included.

FIG. 1C illustrates a schematic flowchart of the image processing in the image processing apparatus of the present exemplary embodiment. The processing of the flowchart may be implemented by execution of the program by the CPU 122 illustrated in FIG. 1B, or may be implemented by processing of each component of hardware corresponding to the program.

Hereinafter, the image processing in the present exemplary embodiment will be described with reference mainly to FIGS. 1A, 1C, 2A to 2D, and 3A to 3D.

In step S101 in FIG. 1C, the setting unit 104 acquires the image format information, and then in step S102, the setting unit 104 sets and outputs the color profile in accordance with the acquired image format. For example, in the case of an SDR image format, the setting unit 104 sets a color profile by assigning a color value corresponding to a white color having predetermined brightness to a maximum tone of an image. For example, in the case of an HDR image format, the setting unit 104 sets a color profile by assigning a color value corresponding to a white color having predetermined brightness to a signal value smaller than a maximum signal value of DR of the image.

In the present exemplary embodiment, a specific setting method will be described by using an ICC profile widely used as a color profile as an example. The ICC profile is one example, and a color profile in another format may be used. The ICC profile is a standard for color profile (ISO 15076-1:2005) standardized by International Color Consortium. In the ICC profile of a display device used for a display apparatus, a three-component matrix base profile is mainly used. In the ICC profile, the signal value of the image and an XYZ stimulus value are associated by a tone reproduction curve (TRC) tag and a matrix column tag of each of RGB primary colors. For example, in the case of AdobeRGB (1998), each of RGB in the TRC tag is set to have a gamma value of 2.2. In the matrix column tag, RGB are set to (0.60974, 0.31111, 0.01947), (0.20528, 0.62567, 0.06087), and (0.14919, 0.06322, 0.74457), respectively.

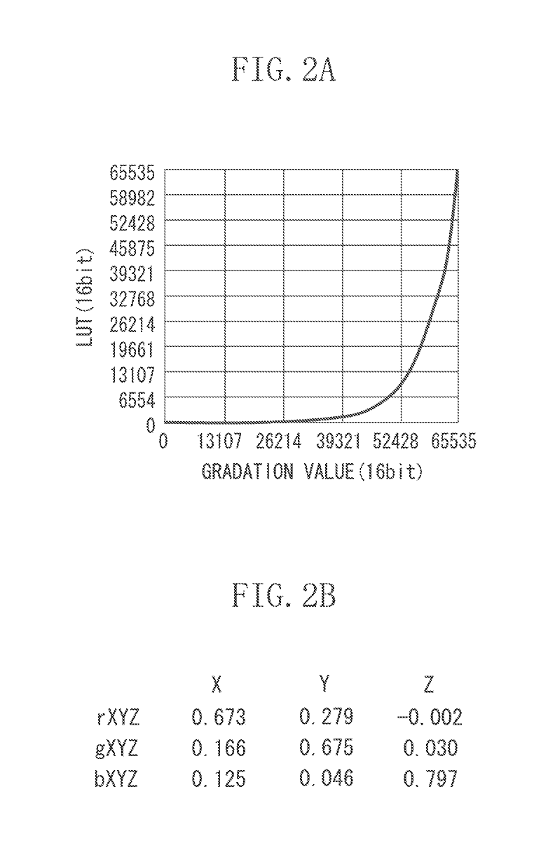

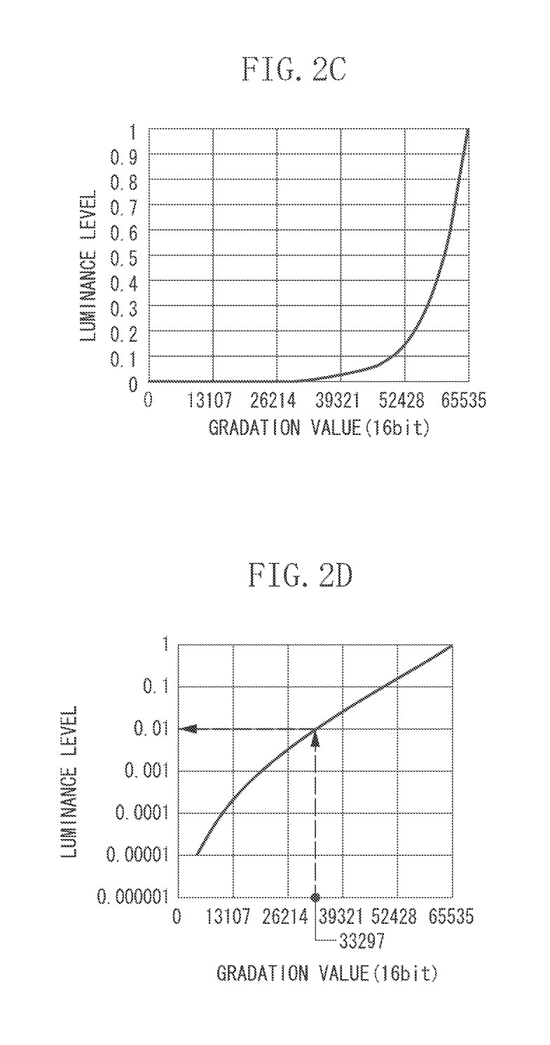

In addition, in the ICC profile of the display device, an RGB total value in the matrix column tag is set to match RGB of (0.950, 1.000, 1.089) of white color of D50. As an example, a case where BT.2100:PQ is set to the ICC profile in accordance with an existing format will be described with reference to FIGS. 2A to 2D. FIG. 2A is a diagram illustrating the TRC tag, FIG. 2B is a diagram illustrating the matrix column tag, FIG. 2C is a diagram illustrating a correspondence between a tone and a luminance level, and FIG. 2D is a diagram illustrating the correspondence between the tone and the luminance level on a logarithmic scale. The TRC illustrated in FIG. 2A represents a curve for PQ. However, since PQ requires a complex mathematical equation, the curve is realized in a format of a look up table (LUT) as the ICC profile. Specifically, a calculation result in the following Equation (1) can be obtained where an input N is set to 16 bits and an output L is set to 16 bits.

$${m}_{1} = 2610 \text{/} 16384 \\ {m}_{2} = 2523 \text{/} 4096 \times 128 \\ {c}_{1} = 3424 \text{/} 4096 \\ {c}_{2} = 2413 \text{/} 4096 \times 32 \\ {c}_{3} = 2392 \text{/} 4096 \times 32 \\ L = round ( 65535 \times {( \frac{max ( {( \frac{N}{65535} )}^{1 / {m}_{2}} - {c}_{1} , 0 )}{{c}_{2} - {{c}_{3} ( \frac{n}{65535} )}^{1 / {m}_{2}}} )}^{1 / {m}_{1}} ) \qquad ( 1 )$$

The calculation result of Equation (1) represents a curve having a shape as illustrated in FIG. 2A. The matrix column tag is set to a value obtained by performing Bradford transformation on RGB color components from D65 to D50 in accordance with a specification of the ICC profile. For example, as illustrated in FIG. 2B, RGB values of the matrix column tag are set to (0.673, 0.279, −0.002), (0.166, 0.675, 0.030), and (0.125, 0.046, 0.797), respectively.

Here, the setting where a sum of RGB matches RGB of D50 is appropriate in SDR, but the setting is not appropriate in HDR which defines a tone of a white color having brightness equal to or higher than brightness of the reference white. For example, a maximum tone in PQ is 10,000 nits (100 times a tone of the reference white of 100 nits). However, the correspondence between the tone and the luminance level of a pixel by the setting of the TRC and the matrix column is a relationship as illustrated in FIG. 2C, and the maximum tone is associated with the luminance level 1.0 of the reference white. A signal value (33297 in the case of 16 bits) corresponding to the reference white in an actual standard is associated with the luminance level 0.01 as illustrated in FIG. 2D.

In addition, in HDR standard, it is necessary that the signal value corresponding to the reference white is associated with the color value (1.0) corresponding to the reference white. Since an output of the curve is associated with 0 to 1.0 in the TRC according to a specification thereof, in the ICC profile, the above-described correspondence between the tone and the color value of the reference white is achieved by changing a value of the matrix column.

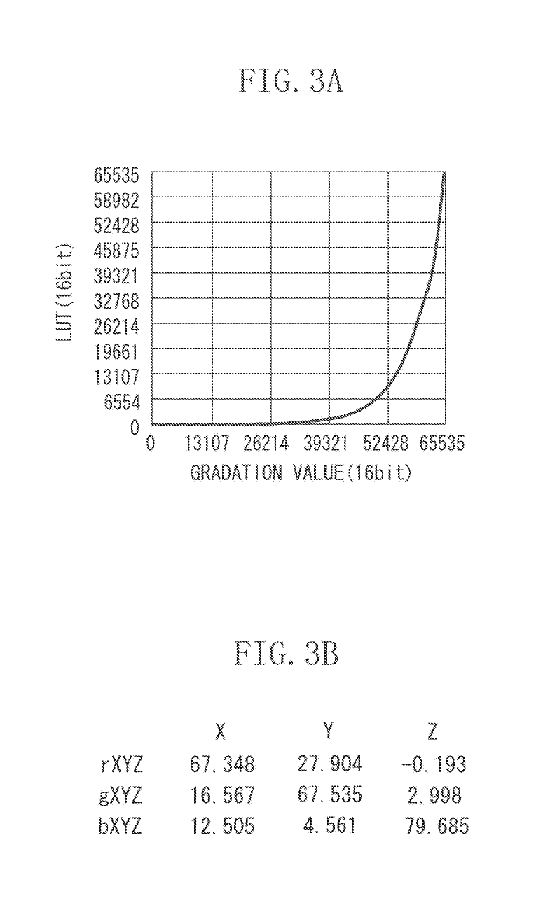

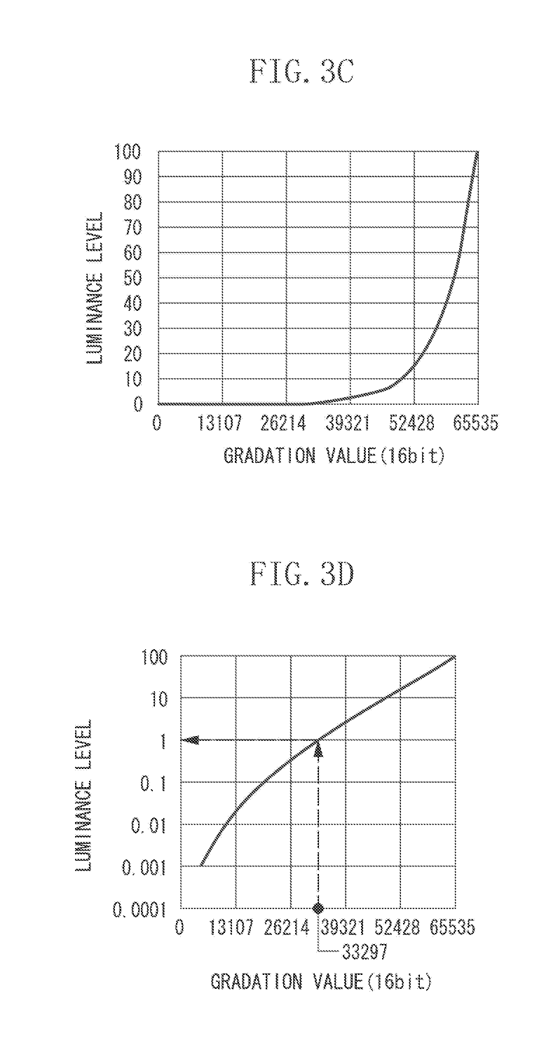

FIGS. 3A to 3D illustrate examples of a color profile setting in the present exemplary embodiment. FIG. 3A is a diagram illustrating the TRC tag, FIG. 3B is a diagram illustrating the matrix column tag, FIG. 3C is a diagram illustrating a correspondence between a tone and a luminance level, and FIG. 3D is a diagram illustrating the correspondence between the tone and the luminance level on a logarithmic scale. In the case of BT.2100:PQ, as illustrated in FIG. 3B, the set values in the above-described matrix column are multiplied by a predetermined value (multiplied by a constant) in accordance with a luminance range of a gamma curve. In the case of BT.2100:PQ, the set value of the matrix column is increased a hundredfold so that the RGB values of the matrix column (R, G, B) becomes (67.3, 27.9, −0.20), (16.6, 67.5, 3.00), and (12.51, 4.56, 79.7), respectively. As a result, although the signal value corresponding to the reference white remains at the output of 0.01 in the TRC, each of the RGB values is changed. As a result of multiplying the value of 0.01 in TRC by the values in the matrix column, the RGB values become (0.673, 0.279, −0.002), (0.166, 0.675, 0.030), and (0.125, 0.046, 0.797), respectively. Thus, a sum of the RGB values becomes (0.950, 1.000, 1.089) and matches RGB values of white color D50. FIG. 3C illustrates the correspondence between the tone and the luminance level. From FIG. 3C, it can be seen that a maximum value in DR is associated with the luminance level 100. In addition, as illustrated in FIG. 3D, it can be seen that a signal value (33297 in the case of 16 bits) corresponding to the reference white is associated with the luminance level 1.0.

The same applies to the case of BT.2100:HLG and the like, in which, by multiplying a matrix array coefficient by a predetermined value (multiplying by a constant) in accordance with the luminance range of the gamma curve, the signal value of the reference white is associated with the color value of the reference white. In addition, the color profile can be set similarly not only for BT.2100 but also for a color space standard specified by an imaging apparatus having HDR.

Although BT.2100:PQ has been described above, various HDR standards defined by a gamma value, a color gamut, and a dynamic range other than the BT.2100:PQ can be set similarly on the ICC profile.

Returning back to the flowchart of FIG. 1C, as the processing of step S103, the conversion unit 105 acquires the above-described input image, and further, as the processing of step S104, converts the signal value of the pixel of the input image in accordance with the image format indicated in the above-described image format information. The image conversion in step S104 is performed by a procedure in which the input image is first converted into color data, and then the color data is converted into data in accordance with the image format. In the present exemplary embodiment, as described above, the input image is the RAW data from the imaging apparatus, and a color gamut is assumed to be sRGB and a tone is assumed to be linear.

If respective input data of RGB are represented by Ir, Ig, and Ib, a color becomes the reference white in the case of Ir=Ig=Ib=1.0. In addition, if tone of respective output is Or, Og, and Ob, for example, in the case of sRGB, conversion into the tones Or, Og, and Ob is performed by the following Equation (2). In the case of AdobeRGB, for example, conversion into the tones Or, Og, and Ob is performed by the following Equation (3). The values of the tones Or, Og, and Ob of the output are 0 to 1, and the conversion unit 105 multiplies the values by coefficients in accordance with a number of bits of the signal, and then converts the values into integers.

$$\begin{matrix}{M}_{in} = {M}_{sRGB} = ( \begin{matrix}0.43604 & 0.22248 & 0.01392 \\ 0.38512 & 0.71691 & 0.09707 \\ 0.14305 & 0.06061 & 0.71391\end{matrix} ) \\ {M}_{out} = {M}_{sRGB} \\ oetf ( x ) \{ \begin{matrix}12.92 \times max ( 0 , min ( 1 , x ) ) , & x ≦ 0.0031308 \\ ( 1 + a ) {( max ( 0 , min ( 1 , x ) ) )}^{1 / 24} , & x > 0.0031308\end{matrix} \\ ( {O}_{r} {O}_{g} {O}_{b} ) = oetf ( ( {I}_{r} {I}_{g} {I}_{b} ) \cdot {M}_{in} \cdot {M}_{out}^{- 1} ) & ( 2 ) \\ {M}_{in} = {M}_{sRGB} = ( \begin{matrix}0.43604 & 0.22248 & 0.01392 \\ 0.38512 & 0.71691 & 0.09707 \\ 0.14305 & 0.06061 & 0.71391\end{matrix} ) \\ {M}_{out} = {M}_{ARGB} = ( \begin{matrix}0.60974 & 0.31111 & 0.01947 \\ 0.20528 & 0.62567 & 0.06087 \\ 0.14919 & 0.06322 & 0.74457\end{matrix} ) \\ oetf ( x ) = {( max ( 0 , min ( 1 , x ) ) )}^{1 / 22} \\ ( {O}_{r} {O}_{g} {O}_{b} ) = oetf ( ( {I}_{r} {I}_{g} {I}_{b} ) \cdot {M}_{in} \cdot {M}_{out}^{- 1} ) & ( 3 )\end{matrix}$$

In the case of BT.2100:PQ, the conversion is performed by Equation (4).

$${M}_{in} = {M}_{sRGB} = ( \begin{matrix}0.43604 & 0.22248 & 0.01392 \\ 0.38512 & 0.71691 & 0.09707 \\ 0.14305 & 0.06061 & 0.71391\end{matrix} ) \\ {M}_{out} = {M}_{2020} = ( \begin{matrix}0.67348 & 0.27904 & - 0.00193 \\ 0.16567 & 0.67535 & 0.02998 \\ 0.12505 & 0.04561 & 0.79685\end{matrix} ) \\ {m}_{1} = 2610 \text{/} 16384 \\ {m}_{2} = 2523 \text{/} 4096 \times 128 \\ {c}_{1} = 3424 \text{/} 4096 \\ {c}_{2} = 2413 \text{/} 4096 \times 32 \\ {c}_{3} = 2392 \text{/} 4096 \times 32 \\ oetf ( x ) = {( \frac{{c}_{1} + {{c}_{2} ( \frac{x}{100} )}^{{m}_{1}}}{1 + {{c}_{3} ( \frac{x}{100} )}^{{m}_{1}}} )}^{{m}_{2}} \\ ( {O}_{r} {O}_{g} {O}_{b} ) = oetf ( ( {I}_{r} {I}_{g} {I}_{b} ) \cdot {M}_{in} \cdot {M}_{out}^{- 1} ) \qquad ( 4 )$$

Although simple image conversion as described above has been described as an example in the present exemplary embodiment, various types of image processing may be added such as conversion of color reproducibility in accordance with an intended use of an image or a user's designation.

In step S105, the output unit 106 receives the color profile output from the setting unit 104 and the image data in which the pixel tone is converted by the conversion unit 105. The output unit 106 then converts the image data into a predetermined file format and generates an image file with the color profile attached thereto. For example, in a case where the image data is an SDR image, the output unit 106 performs JPEG encoding, and attaches the ICC profile as a tag to generate the image file. For example, in a case where the image data is an HDR image, the output unit 106 attaches the ICC profile as a tag to a TIFF format with 16-bit accuracy to generate the image file, since an image quality is remarkably deteriorated in a JPEG format with 8-bit accuracy.

In step S106, the output unit 106 outputs the image file to a subsequent stage.

As described above, the image processing apparatus of the present exemplary embodiment sets the color profile in accordance with the selected image format, and outputs the image file generated by providing the set color profile to the image data. In a case where the image format is SDR, for example, the image processing apparatus sets an existing color profile in which a color value corresponding to a white color is assigned to a maximum signal value in DR of the image. In a case where the image format is HDR, for example, the image processing apparatus sets a color profile in which a color value corresponding to a white color is assigned to a signal value smaller than a maximum signal value of the image. With this arrangement, in a display apparatus, regardless of whether the image format of the image is SDR or HDR, for example, a relationship between a tone and brightness is correctly handled in the CMS, and a correct color and brightness can be displayed.

As described above, according to the image processing apparatus of the present exemplary embodiment, an HDR image can be correctly displayed also on a monitor of a display apparatus corresponding only to SDR. In addition, since the present exemplary embodiment uses a mechanism of the color profile, the HDR image can be displayed, edited, converted, and the like by using existing image display/edit software. And thus dedicated software or the like for handling difference information such as the technique disclosed in Japanese Patent Application Laid-Open No. 2015-172956 is not required.

Although, in the above-described exemplary embodiment, a personal computer and an imaging apparatus are exemplified as application examples of the image processing apparatus, the disclosure is not limited to these examples. The present exemplary embodiment can also be applied to, for example, a surveillance camera, a digital single-lens reflex camera, a mirrorless single-lens camera, a compact digital camera, a camcorder, an in-vehicle camera, a medical camera, and an industrial camera. In addition, the present exemplary embodiment can be applied not only to a personal computer but also to a personal digital assistant such as a tablet terminal, a personal handyphone system (PHS), a smart phone, a feature phone, and a portable game machine.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-034735, filed Feb. 28, 2018, which is hereby incorporated by reference herein in its entirety.

What is claimed is:

1. An image processing apparatus, comprising at least one processor configured to function as following units:
a setting unit configured to set a color profile corresponding to an image format selected from a plurality of image formats;
a conversion unit configured to convert an input image into a converted image in the selected image format; and
an output unit configured to output the converted image with at least the color profile attached to the image,
wherein the setting unit
sets, in a case where the input image is converted by the conversion unit into the converted image in a first image format, a first color profile in which a color value corresponding to a white color indicating predetermined brightness is assigned to a maximum signal value of the input image, and
sets, in a case where the input image is converted by the conversion unit into the converted image in a second image format having a wider dynamic range than a dynamic range of the first image format, a second color profile in which the color value corresponding to the white color indicating the predetermined brightness to a signal value smaller than the maximum signal value of the input image.

2. The image processing apparatus according to claim 1, wherein the conversion unit converts the input image into color data, and converts the color data into data in the selected image format.

3. The image processing apparatus according to claim 1, wherein the output unit outputs an image file in a predetermined file format in which the color profile is attached to the converted image.

4. The image processing apparatus according to claim 1, wherein the plurality of image formats includes an image format having a high dynamic range.

5. The image processing apparatus according to claim 4, wherein the second image format is the image format having a high dynamic range.

6. The image processing apparatus according to claim 1, wherein the input image is image data including information received by each imaging element of an imaging apparatus.

7. The image processing apparatus according to claim 1,
wherein the color profile includes information of a gamma and a color gamut corresponding to the selected image format, and
wherein the setting unit sets, in a case where the input image is converted into the converted image in the second image format, the color profile in such a manner that the information of the color gamut is multiplied by a predetermined value based on the information of the gamma in the second image format.

8. An image processing method executed by an image processing apparatus, the image processing method comprising:
setting a color profile corresponding to an image format selected from a plurality of image formats;
converting an input image into a converted image in the selected image format; and
outputting the converted image with at least the color profile attached to the image,
wherein, in the setting,
in a case where the input image is converted into the converted image in a first image format, a first color profile in which a color value corresponding to a white color indicating predetermined brightness is assigned to a maximum signal value of the input image is set, and
in a case where the input image is converted into the converted image in a second image format having a wider dynamic range than a dynamic range of the first image format, a second color profile in which the color value corresponding to the white color indicating the predetermined brightness to a signal value smaller than the maximum signal value of the input image is set.

9. A non-transitory computer-readable storage medium storing a program for causing a computer to execute following steps comprising:
setting a color profile corresponding to an image format selected from a plurality of image formats;
converting an input image into a converted image in the selected image format; and
outputting the converted image with at least the color profile attached to the image,
wherein, in the setting,
in a case where the input image is converted into the converted image in a first image format, a first color profile in which a color value corresponding to a white color indicating predetermined brightness is assigned to a maximum signal value of the input image is set, and
in a case where the input image is converted in the converting into the converted image in a second image format having a wider dynamic range than a dynamic range of the first image format, a second color profile in which the color value corresponding to the white color indicating the predetermined brightness to a signal value smaller than the maximum signal value of the input image is set.
